(19) United States
(12) Patent Application Publication
(10) Pub. No.: US 2008/0296139 A1
(43) Pub. Date: Dec. 4, 2008

(54) HAND-OPERATED DEVICE

(76) Inventors: Quintin MORRIS, Brooklyn, NY (US); Chandra Nair, Mount Sinai, NY (US); Curt Croley, Stony Brook, NY (US)

Correspondence Address: FAY KAPLUN & MARCIN, LLP, 150 BROADWAY, SUITE 702, NEW YORK, NY, 10038, US

(21) Appl. No.: 11/757,507

(22) Filed: Jun. 4, 2007

(51) Int. Cl. H01H 1/00

(52) U.S. Cl. 200/502

(57) ABSTRACT

Described is a device which includes an attachment arrangement for coupling the device to at least one finger of a user. The device also includes a trigger arrangement which, when the device is located anywhere along a length of the at least one finger, is positioned for activation by a thumb of the user regardless of a position of the at least one finger. When the at least one finger is in a folded position, a first end of the trigger arrangement is positioned for activation by the thumb and, when the at least one finger is in an unfolded position, a second end of the trigger arrangement is positioned for activation by the thumb.

### FIELD OF INVENTION

The present application generally relates to hand-operated devices.

### BACKGROUND INFORMATION

Electronic devices include hand-operated devices which, during use, are positioned on or about a user's hand. The devices are triggered using a finger or thumb of the user. A conventional hand-operated device generally includes a trigger arrangement in the form of a switch which is fixed in size. As a result, the conventional device may not accommodate different users. For example, differences in finger size may cause the conventional device to be positioned so as to make triggering difficult or uncomfortable. When the switch is too big, user movement may be unnecessarily restricted. When the switch is too small, the user may have difficulty reaching for the switch.

In addition, normal usage may require different triggering positions in which a position of the trigger arrangement varies between the different triggering positions. Because the size of the trigger arrangement is fixed, triggering may be comfortable in one position and difficult or uncomfortable in a second position. Thus, user characteristics and/or changing operating conditions may affect the user's comfort or ability to operate the conventional device.

### SUMMARY OF THE INVENTION

The present invention relates to a device which includes an attachment arrangement for coupling the device to at least one finger of a user. The device also includes a trigger arrangement which, when the device is located anywhere along a length of the at least one finger, is positioned for activation by a thumb of the user regardless of a position of the at least one finger. When the at least one finger is in a folded position, a first end of the trigger arrangement is positioned for activation by the thumb and, when the at least one finger is in an unfolded position, a second end of the trigger arrangement is positioned for activation by the thumb.

The present invention also relates to a device which includes an attachment means for coupling the device to at least one finger of a user. The device also includes a trigger means which, when the device is located anywhere along a length of the at least one finger, is positioned for activation by a thumb of the user regardless of a position of the at least one finger. When the at least one finger is in a folded position, a first end of the trigger means is positioned for activation by the thumb and, when the at least one finger is in an unfolded position, a second end of the trigger means is positioned for activation by the thumb.

### BRIEF DESCRIPTION OF THE DRAWINGS

FIG. 1 shows a profile view of a hand-operated device according to an exemplary embodiment of the present invention.

FIG. 2 shows a profile view of various exemplary embodiments of a trigger arrangement according to the present invention.

FIG. 3 shows a first triggering position of a device according to an exemplary embodiment of the present invention.

FIG. 4 shows a second triggering position of a device according to an exemplary embodiment of the present invention.

FIG. 5 shows a third triggering position of a device according to an exemplary embodiment of the present invention.

FIG. 6 shows a fourth triggering position of a device according to an exemplary embodiment of the present invention.

FIG. 7 shows a fifth triggering position of a device according to an exemplary embodiment of the present invention.

FIG. 8 shows a sixth triggering position of a device according to an exemplary embodiment of the present invention.

### DETAILED DESCRIPTION

The present invention may be further understood with reference to the following description and the appended drawings, wherein like elements are provided with the same reference numerals. The present invention relates to hand-operated devices (e.g., devices that may be activated using a portion of a hand). Exemplary embodiments of the present invention will be described below with reference to a trigger arrangement for a wearable data acquisition device (e.g., a ring scanner). However, those skilled in the art will understand that the present invention may be implemented with any electrical and/or mechanical hand-operated device. Thus, in other embodiments, the present invention may be used in conjunction with other hand-operated devices such as image or laser-based scanners, RFID readers, GPS handhelds, motion or touch-sensitive gloves, multimedia devices (e.g., audio or video players), two-way radios, cell phones, sound-activated handhelds, data transmission devices, wrist-mounted computers, laser pointers, multimedia presenters, etc.

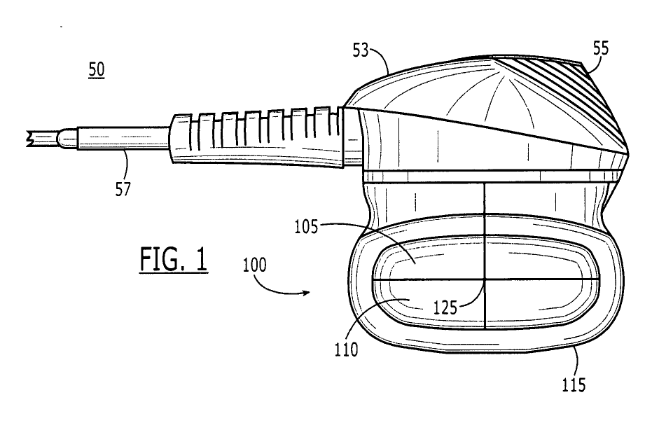

FIG. 1 shows a profile view of a hand-operated device (e.g., a data acquisition device 50) according to the present invention. The data acquisition device 50 may be a ring scanner worn over one or more fingers (e.g., an index finger or a middle finger) of the user. A housing 53 of the data acquisition device 50 may include a data acquisition arrangement (e.g., a barcode scanning arrangement 55) located at a distal end thereof. The data acquisition device 50 may be communicatively coupled to a further device (not shown) such as, for example, a data acquisition terminal or a mobile computer, via a cable 57.

As shown in FIG. 1, the data acquisition device 50 may also include a trigger arrangement 100 which includes a trigger mechanism (e.g., a switch 110). The trigger arrangement 100 may be worn over the index finger using any number of techniques known in the art. For example, in one embodiment, a housing of the trigger arrangement 100 may be shaped (e.g., cylindrical) to accommodate the index finger. In another embodiment, the trigger arrangement 100 may include an attachment mechanism (e.g., a strap, a band, a glove, etc.) by which the trigger arrangement 100 may be worn over the one or more fingers. The trigger arrangement 100 may be integrally formed with the housing 53 or, alternatively, may be formed separately. In one embodiment, the trigger arrangement 100 may be detachable from the housing 53. The trigger arrangement 100 may also be rotatable about an axis of the housing 53. If the trigger arrangement 100 is rotatable, a center (e.g., a front-to-back center) of the trigger arrangement 100 may be aligned with a center of rotation (e.g., the axis of the housing 53).

In the exemplary embodiment shown in FIG. 1, the switch 110 is a pushable button. However, those skilled in the art will understand that the switch 110 may be any electrical and/or mechanical triggering mechanism including a touch sensor, a motion sensor, a slide switch, a rocker switch, etc. If the trigger arrangement 100 is worn over the index finger, the switch 110 may be engaged using a thumb. Alternatively, if the trigger arrangement 100 is worn over the middle finger, the engaging may be performed using a portion of the index finger (e.g., a knuckle).

As will be described in detail below, the trigger arrangement 100 may be worn anywhere along the user's finger. A length of the trigger arrangement 100 may occupy a distance between one or more joints of the finger. For example, in one embodiment, a proximal portion of the trigger arrangement 100 may be located along a proximal phalanx while a medial portion 125 and a distal portion 115 may be located further distally along the proximal phalanx. In another embodiment, the proximal portion 105 may be located along an intermediate phalanx while the distal portion 115 may be located along a distal phalanx. Other wear locations (e.g., along multiple fingers) may be possible and will be apparent to those skilled in the art.

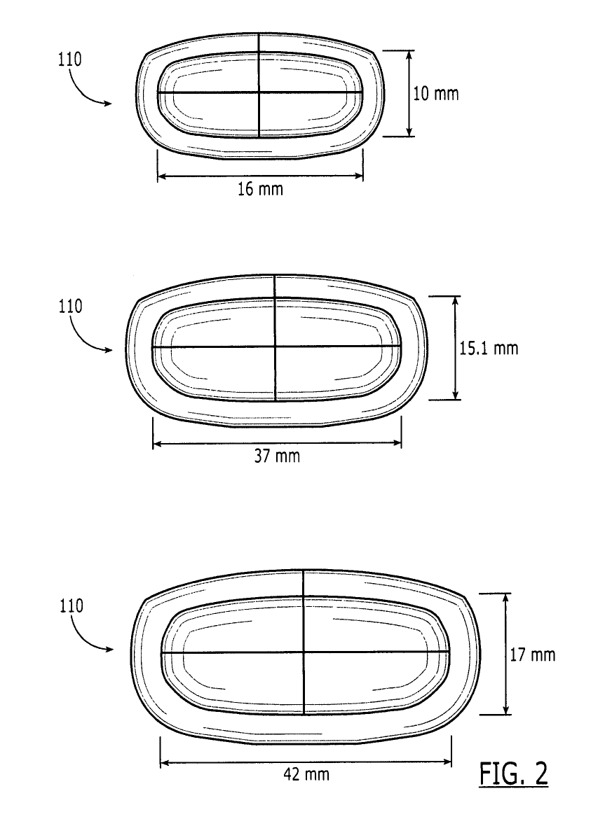

FIG. 2 shows a profile view of various exemplary embodiments of the trigger arrangement 100 in which each embodiment has a different size switch 110 than the other embodiments. As shown in FIG. 2, a first preferred embodiment has a length of 16 mm and a width of 10 mm, a second preferred embodiment has a length of 37 mm and a width of 15.1 mm, and a third preferred embodiment has a length of 42 mm and a width of 17 mm. Those skilled in the art will understand that the dimensions shown are only exemplary and that exact dimensions of the trigger arrangement 100 may vary across different embodiments depending on a desired wear location. For example, the first embodiment may be sized appropriately for wear on the distal phalanx, the second embodiment may be sized for wear on the intermediate phalanx and the third embodiment may be sized for wear on the proximal phalanx.

In addition to varying the switch size, it may also be possible to vary the size of the housing of the trigger arrangement 100 in proportion to the size of the switch 110. For example, the first preferred embodiment may correspond to a “small” trigger housing, the second preferred embodiment may correspond to a “medium” trigger housing and the third preferred embodiment may correspond to a “large” trigger housing.

If a different size trigger arrangement 100 is desired, the user may detach a current trigger arrangement 100 and replace it with another. The detaching and replacement may occur via any number of attachment mechanisms known to those skilled in the art, including, for example, Velcro®, stretchable bands, buckled straps, magnets, snap-fitting and rotating locks. If the trigger arrangement 100 is integral with the housing 53, the user may discard the entire data acquisition device 50 and select another data acquisition device 50 that has a more appropriately sized trigger arrangement 100.

Triggering of the data acquisition device 50 occurs when the trigger arrangement 100 is engaged by, for example, pushing the switch 110. The pushing may occur anywhere along a length of the switch 110, ranging from the proximal portion 105 to the distal portion 115. The switch 110 may be formed to produce a similar audio and/or tactile response (e.g., a click) when engaged anywhere along the length thereof. Thus, the switch 110 may be substantially uniform along its entire length. In addition, the switch 110 may be substantially symmetrical such that if the trigger arrangement 100 is rotated between a left-handed and a right-handed operating position, a behavior of the switch 110 may be the same regardless of an orientation of the trigger arrangement 100.

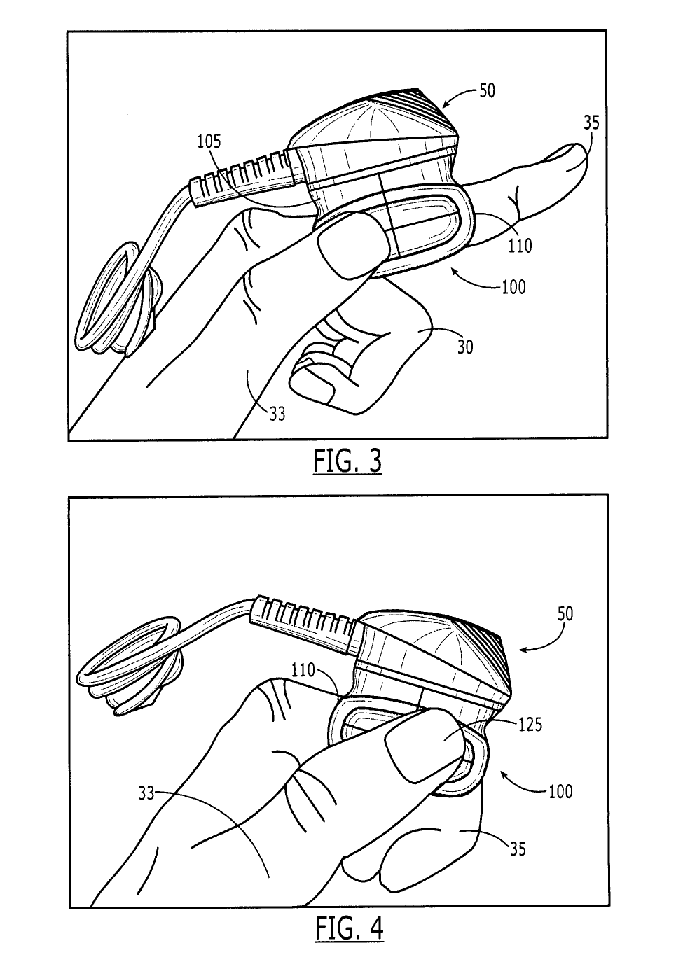

The trigger arrangement 100 will now be described with reference to various triggering (or activation) positions which, as would be understood by those skilled in the art, may be a function of the wear location and/or a position of a trigger finger (e.g., a thumb) relative to the trigger arrangement 100. Because the position of the trigger finger relative to the trigger arrangement 100 can change during a course of usage, it is important that the trigger arrangement 100 enable the user to comfortably engage the switch 110 even if the relative position is changed. For example, as will be described with reference to FIGS. 3-8, if the wear location is along a length of a finger (e.g., the index finger), a position of the trigger arrangement 100 relative to the trigger finger (e.g., the thumb) may change as a result of bending or folding the index finger, stretching a palm, closing the palm, rotating the hand about a wrist, etc.

In the exemplary embodiments shown in FIGS. 3-8, the switch 110 is sized the same throughout each figure in order to illustrate an ability of the trigger arrangement 100 to accommodate different wear locations and triggering positions. As will be described below, the trigger arrangement 100 may be worn along the index finger. Thus, a position of the data acquisition device 50 may be varied by moving the index finger (e.g., folding or bending). This may be useful when operating the data acquisition device 50 (e.g., scanning a barcode), since the position of the data acquisition device 50 may need to be varied relative to a barcode in order to successfully perform a barcode data capture. Depending on where the barcode is located (e.g., whether the barcode is near or far away, angled towards or away from the data acquisition device 50, etc.), the user can position the data acquisition device 50 using the index finger and then perform the barcode capture by engaging the trigger arrangement 100. For example, if the barcode is far away, the triggering position may be one in which the fingers are extended and pointing towards the barcode. If the barcode is nearby, the triggering position may be one in which the fingers are folded or curled towards the palm. The position of the data acquisition device 50 may also be adjusted using movements of the palm, the wrist, a forearm and other body movements that may change the position of the trigger finger relative to the trigger arrangement 100.

FIG. 3 shows a first triggering position according to an exemplary embodiment of the data acquisition device 50 in which the trigger arrangement 100 is worn along the proximal phalanx of an index finger 35 with a thumb 33 pointing in the same general direction (e.g., substantially co-planar to the index finger 35). In the first triggering position, the switch 110 is engaged along the proximal portion 105.

FIG. 4 shows a second triggering position according to an exemplary embodiment of the data acquisition device 50 in which the trigger arrangement 100 is worn along the proximal phalanx, but the fingers, including the index finger 35, are folded towards the palm. In this triggering position, the switch 110 is engaged by the thumb 33 along the medial portion 125. As shown in FIG. 4, the hand is oriented along a substantially horizontal plane.

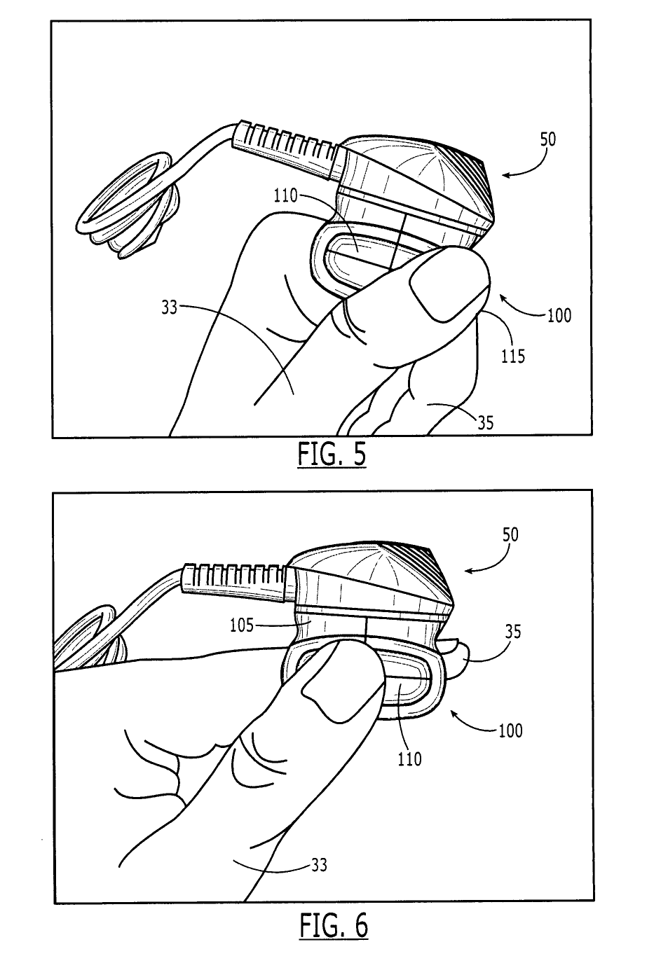

FIG. 5 shows a third triggering position according to an exemplary embodiment of the data acquisition device 50 in which the trigger arrangement 100 is worn along the proximal phalanx and the index finger 35 is folded towards the palm. The position of the fingers is substantially the same as in FIG. 4, except the thumb 33 engages the switch 110 along the distal portion 115.

As illustrated in FIGS. 3-5, the same trigger arrangement 100 can accommodate different triggering positions based on the same wear location (e.g., the proximal phalanx). The following figures illustrate an ability of the trigger arrangement 100 to also accommodate different wear locations.

FIG. 6 shows a fourth triggering position according to an exemplary embodiment of the data acquisition device 50 in which the trigger arrangement 100 is worn between a proximal end of the intermediate phalanx and a distal end of the distal phalanx. The fingers are substantially co-planar except for the thumb 35, which is oriented at an angle to the index finger 35 to engage the proximal portion 105 of the switch 110.

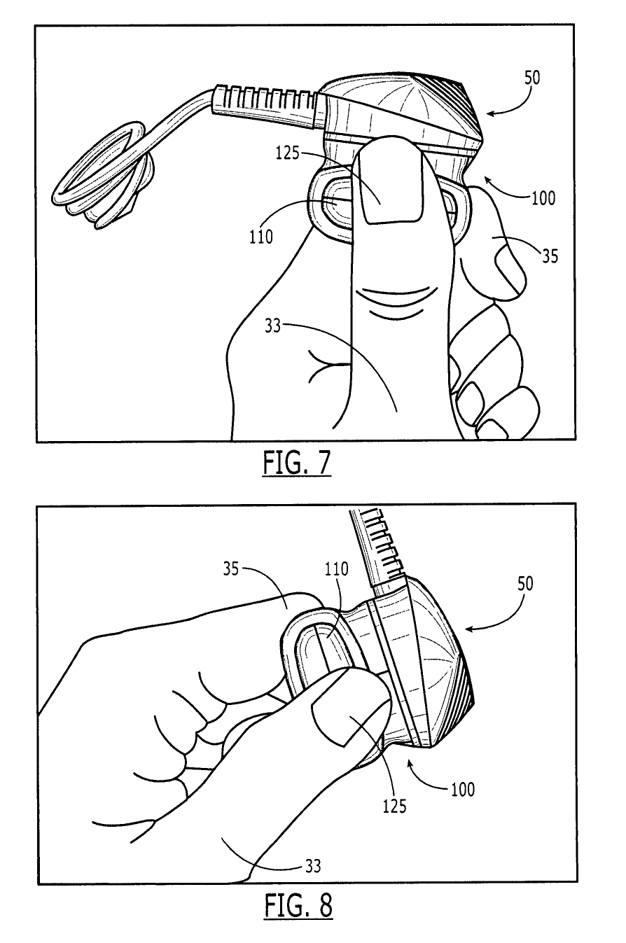

FIG. 7 shows a fifth triggering position according to an exemplary embodiment of the data acquisition device 50 in which the trigger arrangement 100 is worn along the intermediate phalanx and the thumb 33 engages the switch 110 along the medial portion 125. The fingers are folded towards the palm and the hand is oriented substantially parallel to a vertical plane.

FIG. 8 shows a sixth triggering position according to an exemplary embodiment of the data acquisition device 50 in which the trigger arrangement 100 is worn along the intermediate phalanx and the thumb 33 engages the medial portion 125 of the switch 110. The fingers are folded towards the palm and the hand has been rotated such that the data acquisition device 50 is oriented at an angle to the vertical plane.

Based on the exemplary embodiments described above, it can be seen that the present invention provides substantial advantages over conventional hand-operated devices. Utilizing the present invention, the user is able to select a trigger arrangement 100 that fits in accordance with the user's physical and/or usage characteristics. For instance, the user may select the trigger arrangement 100 based on a combination of a desired wear location and a size of a body part corresponding to that wear location. As discussed above, relevant usage characteristics such as the distance between the trigger finger and the trigger arrangement 100 during a particular triggering position may also be considered when selecting the trigger arrangement 100. The user can select the trigger arrangement 100 that is sized to allow comfortable triggering during frequently encountered triggering positions.

In addition, the user may select the trigger arrangement 100 that is sized to allow comfortable triggering across different wear locations. For example, the user may, at times, wish to switch between a first wear location and a second wear location. Thus, the user is not constrained to operating the data acquisition device 50 on a single wear location.

Because the frequently encountered positions may be a function of user-determined relationships (e.g., wear location) as well as predetermined positional relationships (e.g., a predetermined distance or a predetermined angle between the data acquisition device 50 and the barcode), the present invention may enable the user to adapt the data acquisition device 50 to conditions within the user's control as well as conditions outside of the user's control.

Although the trigger arrangement 100 has been described with exclusive reference to a single on-off type switch (i.e., the switch 110), it may also be possible to implement the present invention using multi-positional triggers. For example, in other embodiments each of the proximal portion 105, the medial portion 125 and the distal portion 115 may trigger a different function, which may be predetermined or user determined. Thus, different triggering positions may correspond to different functions. The benefits of the present invention may be appreciable in an embodiment utilizing a multi-position trigger, since operation of the data acquisition device 50 may require access to multiple triggering positions, whereas single-position embodiments may only require one triggering position.

The present invention has been described with reference to the above exemplary embodiments. Those skilled in the art will understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
an attachment arrangement coupling the device to at least one finger of a user; and
a trigger arrangement which, when the device is located anywhere along a length of the at least one finger, is positioned for activation by a thumb of the user regardless of a position of the at least one finger,
wherein, when the at least one finger is in a folded position, a first end of the trigger arrangement is positioned for activation by the thumb and, when the at least one finger is in an unfolded position, a second end of the trigger arrangement is positioned for activation by the thumb.

2. The device according to claim 1, wherein a length of the trigger arrangement from the first end to the second end is between 16 mm and 42 mm and a width of the trigger arrangement is between 10 mm and 17 mm.

3. The device according to claim 1, wherein the device is one of a barcode scanner, an image-based scanner, a laser-based scanner, an RFID reader, a GPS handheld, a motion sensitive glove, a touch-sensitive glove, a multimedia device, a two-way radio, a cell phone, a sound-activated handheld, a data transmission device, a wrist-mounted computer, a laser pointer and a multimedia presenter.

4. The device according to claim 1, wherein the trigger arrangement includes one of a pushable button, a touch sensor, a motion sensor, a slide switch and a rocker switch.

5. The device according to claim 1, wherein the trigger arrangement is rotatably coupled to a housing of the device.

6. The device according to claim 1, wherein the trigger arrangement is detachably coupled to a housing of the device.

7. The device according to claim 1, wherein the first end is one of a proximal portion, a medial portion and a distal portion of the trigger arrangement.

8. The device according to claim 1, wherein the second end is one of a proximal portion, a medial portion and a distal portion of the trigger arrangement.

9. The device according to claim 1, wherein the attachment arrangement includes one of a strap, a band and a glove.

10. The device according to claim 1, wherein activating the first end triggers a first function of the device that is different from a second function triggered by activating the second end.

11. The device according to claim 1, wherein activating the first end triggers the same function of the device as activating the second end.

12. The device according to claim 1, wherein the folded and unfolded positions correspond to a respective position of the trigger arrangement relative to an object upon which the object operates.

13. The device according to claim 12, wherein the relative position is one of distance.

14. The device according to claim 13, wherein the folded position corresponds to a first distance and the unfolded position corresponds to a second distance, the first distance being less than the second distance.

15. The device according to claim 12, wherein the relative position is one of orientation.

16. The device according to claim 1, wherein an angle of rotation of a hand about a wrist of the user is different between the folded and unfolded positions.

17. The device according to claim 1, wherein the trigger arrangement is worn between proximal and distal portions of a finger phalanx.

18. The device according to claim 1, wherein the trigger arrangement is worn between adjacent finger phalanxes.

19. The device according to claim 1, wherein a finger location at which the trigger arrangement is worn during the first position is different from a finger location at which the trigger arrangement is worn during the second position.

20. A device, comprising:
an attachment means for coupling the device to at least one finger of a user; and
a trigger means which, when the device is located anywhere along a length of the at least one finger, is positioned for activation by a thumb of the user regardless of a position of the at least one finger, wherein, when the at least one finger is in a folded position, a first end of the trigger means is positioned for activation by the thumb and, when the at least one finger is in an unfolded position, a second end of the trigger means is positioned for activation by the thumb.
